(19) United States
(12) Patent Application Publication
(10) Pub. No.: US 2022/0250267 A1
(43) Pub. Date: Aug. 11, 2022

(54) CUTTING TOOL

(71) Applicant: Eickhorn-Solingen Ltd., Solingen (DE)

(72) Inventor: Stuart Gregory Kerr, Solingen (DE)

(21) Appl. No.: 17/432,418

(22) PCT Filed: Feb. 22, 2019
(86) PCT No.: PCT/EP2019/054446

§ 371 Date: Aug. 19, 2021

(51) Int. Cl. B26B 29/02; B26B 5/00; B26B 11/00

(52) U.S. Cl. CPC B26B 29/02; B26B 11/00; B26B 5/006

(57) ABSTRACT

A tool for cutting a longitudinal object includes a grip extending between a first side and a second side in a first direction, and a blade arranged in a channel within the grip. The channel and the blade are arranged such that the longitudinal object is receivable and guidable toward the blade by the channel. In the first direction, the channel is arranged closer to the first side than to the second side of the grip. The tool further includes a guiding element, which is attached to the grip at an attachment point. The attachment point is, in the first direction, located between a channel entrance and the first side. The guiding element is attached to the grip in a foldable manner such that if folded out the guiding element extends from the grip to guide the longitudinal object toward the channel entrance.

The present invention is directed to a cutting tool, particularly a tool for cutting a longitudinal object. Further, the present invention is directed to a use of such a tool for cutting single-use handcuffs, in particular configured in a cable tie manner.

Various cutting tools are known from the prior art. Among them are simple knifes or more elaborate tools having foldable knife elements such as pocketknives. Most cutting tools are useful for various objects to be cut. For some applications, however, common cutting tools are not suitable because due to sharp blades there is a severe risk of injury. An example of such an application is cutting single-use handcuffs. These often comprise plastic strings that are fastened in a way known from cable ties. Cutting the plastic string of a single-use handcuff with a knife is not reasonable because the cuffed person might get injured by the knife. The same problem occurs when using scissors or a wire cutter.

It is, therefore, an object of the present invention to overcome at least in part the disadvantages known from prior art and, in particular, to provide a tool for cutting longitudinal objects such as plastic strings, threads, cords, ropes or wires, in particular single-use handcuffs, in a particularly safe way.

These objects are solved by the features of the independent claims. Dependent claims are directed to preferred embodiments of the present invention.

According to the invention a tool is provided for cutting a longitudinal object. The tool comprises:
a grip extending between a first side and a second side in a first direction,
a blade arranged in a channel within the grip, wherein the channel and the blade are arranged such that the longitudinal object is receivable and guidable toward the blade by the channel, wherein, in the first direction, the channel is arranged closer to the first side than to the second side of the grip,
a guiding element, which is attached to the grip at an attachment point, wherein the attachment point is, in the first direction, located between a channel entrance and the first side, wherein the guiding element is attached to the grip in a foldable manner such that if folded out the guiding element extends from the grip to guide the longitudinal object toward the channel entrance.

The tool can be used to cut any longitudinal object such as, for example, a plastic string, a thread, a cord, a rope or a wire. In particular, the tool can be used to cut single-use handcuffs, in particular if these comprise a plastic string as the longitudinal object. The single-use handcuff can be configured in a cable tie manner. That is, the single-use handcuff can have a plastic string, one end of which being configured to be attachable to the plastic string so as to form a closed loop that can be reduced in size, but not enlarged. Such single-use handcuffs are often used by the police in situations where a large number of people need to be cuffed. Preferably, the tool and its components are each configured in a way suitable to cut single-use handcuffs.

Using the described tool is particularly safe. This is due to the fact that the blade is confined within the tool in such a way that only a longitudinal object of a respective size can come into contact with the blade, whereas parts of the human body, in particular fingers, cannot.

To achieve this safety, the blade is arranged in the channel within the grip. The grip can be of basically cuboidal shape. From a perfect cuboid the shape can deviate in particular in terms of rounded edges and/or shape elements for technical and/or aesthetic purposes. For example, the shape of the grip can be configured such that it can be gripped particularly well by a hand of a user.

In order to describe the tool, a coordinate system is used having a first direction, a second direction and a third direction, each of which being orthogonal to both respective other directions. Along the first direction the grip extends between the first side and the second side. The first side and the second side are defined to be the outmost points of the grip along the first direction. The extension of the grip along the first direction can be considered as a length of the grip. The length is preferably in the range of 10 to 15 cm. The extension of the grip along the second direction can be considered as a thickness of the grip. The thickness is measured between the outmost points of the grip along the second direction. The thickness of the grip is preferably in the range of 0.5 to 2 cm. The extension of the grip along the third direction can be considered as a width of the grip. The width is measured between the outmost points of the grip along the third direction. The width is preferably in the range of 2.5 to 5 cm.

The tool further comprises the blade. The blade can be used to cut the longitudinal object. Preferably, the blade is configured in a razor blade manner. Due to the fact that the blade is arranged within the channel the blade cannot come into contact with parts of the body of a user, such as a finger. Preferably, the channel is configured in such a way that the user of the tool cannot touch the blade. That is, the channel and the blade are preferably configured and arranged such that the blade is inaccessible for a user. Therein, inaccessible means that the user cannot touch the blade in operation of the tool. Only for maintenance purposes such as exchanging the blade may the user be able to touch the blade, for example after disassembling the tool at least partly.

The channel extends between the channel entrance and the blade. The channel entrance is an opening within the surface of the grip through which the longitudinal object can access the channel. From the channel entrance the longitudinal object can be guided by the channel toward the blade. The channel is preferably open on two opposite sides such that the longitudinal object can extend out of the channel on both sides. This way, also very long longitudinal objects and even closed loops can be cut by the tool. Preferably, the channel is open along the second direction such that the longitudinal object can be cut if the longitudinal object is arranged along the second direction.

The channel is arranged closer to the first side than to the second side. This way, the first side can be distinguished from the second side. The first side is that side of the grip that is close to the channel. Preferably, a distance between the channel entrance and the first side of the grip is between 1 and 5 cm, in particular between 2 and 4 cm. The distance is measured from the center of the channel entrance. Such distance is particularly useful in order to cut longitudinal objects that are in close contact with a surface.

In order to introduce the longitudinal object into the channel the guiding element is provided. The guiding element is foldable and can be in a folded-in position, in a folded-out position or in between these two positions. In the following, the expressions “folded in” and “folded out” refer to the folded-in position or the folded-out position, respectively. That is, “folded in” and “folded out” mean that the guiding element is completely folded in or out, respectively. If folded out, the guiding element extends from the grip such that the longitudinal object is guidable by the guiding element toward the channel entrance. Preferably, the guiding element is configured in a manner of a pocketknife element.

Due to the fact that the guiding element is foldable, the guiding element can be stored conveniently if not in use. If this was not possible, the guiding element would have to be restricted in length significantly. In other words, due to the foldability of the guiding element the guiding element can be particularly long. Thus, a particularly pronounced lever effect can be achieved when separating the longitudinal object from a surface it might be in close contact with. Also the handling of the tool is particularly simple if a particularly long guiding element is used.

The guiding element can be moved between the string of a single-use handcuff and the arm of a cuffed person. Even if the single-use handcuff is fastened particularly tightly, the single-use handcuff can be cut using the tool because with the guiding element, the single-use handcuff can be introduced into the channel where it can be cut by the knife. With the blade being confined within the channel, the cuffed person cannot be injured.

The guiding element is attached to the grip at an attachment point, preferably in a manner to allow the guiding element to rotate about an axis through the attachment point. By this rotation, the guiding element can be folded in and out. Thus, the attachment point can be considered the center of rotation of the guiding element.

Seen along the first direction, the attachment point is located between the channel entrance and the first side of the grip. That is, the guiding element is located between the channel entrance and that side of the grip that is closest to the channel entrance. This way it is possible to move the guiding element between the single-use handcuff and the arm of a cuffed person. Also, for other applications it can be useful to have the guiding element arranged as described. For example, the user may use the guiding element in a hook-like manner in order to grip the longitudinal object. Often, longitudinal objects that have to be cut are in close contact to a surface. This is true, for example, for a cable tie that is in close contact to cables that must not be damaged. With the described tool, the guiding element can be moved between the cable tie and the cable in order to guide the cable tie toward the channel entrance and, eventually, toward the blade.

According to a preferred embodiment of the tool the guiding element has a guiding surface that is in line with a channel surface of the channel if the guiding element is folded out.

The guiding surface of the guiding element is preferably the surface of the guiding element that faces the second side of the grip if the guiding element is folded out. The guiding surface is in line with the surface of the channel, in particular with that part of the channel surface that also faces the second side of the grip. The fact that theses surfaces are in line means that there is no step or bump where the two surfaces meet. Thus, the two surfaces jointly allow smooth guidance of the longitudinal object.

According to a further preferred embodiment of the tool the guiding element is tapered toward a tip of the guiding element.

The fact that the guiding element is tapered means that the extension of the guiding element at the attachment point is larger than the extension of the guiding element at the tip of the guiding element. In between, the extension preferably decreases from the attachment point toward the tip in a monotonous manner. That is, starting from the attachment point, the extension may only become smaller or remain the same, but may not become larger again. Preferably, the guiding element is tapered toward a tip of the guiding element as seen in a plane spanned by the first and third directions. That is, the extension of the guiding element in this plane is configured as described, whereas the extension of the guiding element along the second direction preferably remains the same.

According to a further preferred embodiment of the tool the guiding element has a rounded tip.

With a rounded tip it can be particularly easy to move the guiding element between the longitudinal object and a surface the longitudinal object is in close contact with. For example, moving the guiding element between a single-use handcuff and an arm of a cuffed person can be facilitated by the rounded tip. This can further reduce the risk of injuring the cuffed person.

Preferably, the guiding element has a rounded tip as seen in a plane spanned by the first and third directions. The extension of the guiding element along the second direction preferably remains the same.

According to a further preferred embodiment of the tool the guiding element, the channel and the blade are arranged such that the longitudinal object, once received in the channel, can be forced onto the blade by the guiding element by folding in the guiding element.

In this embodiment the longitudinal object can be moved through the channel by folding in the guiding element. That is, a force directed toward the blade can be applied to the longitudinal object using the guiding element as a lever. That way, even particularly firm longitudinal objects can be cut.

According to a further preferred embodiment of the tool the guiding element is contained in a recess within the grip if the guiding element is folded in.

The recess and the guiding element are preferably configured such that the guiding element can be received by the recess such that the guiding element does not extend in any way from the grip if the guiding element is folded in. That way the tool can be easily stored without the guiding element extending from the grip in an inconvenient way.

According to a further preferred embodiment of the tool the guiding element is lockable if folded out and/or if folded in.

Preferably, the guiding element is lockable only if folded out. Alternatively, it is preferred that the guiding element is lockable only if folded in. As yet another alternative it is preferred that the guiding element is lockable if folded in and is lockable if folded out. By locking the guiding element in the folded-in position an unintended folding out of the guiding element can be avoided. By locking the guiding element in the folded-out position the guiding element can be prevented from folding in operation.

According to a further preferred embodiment of the tool the channel is tilted in such a way that, in the first direction, the blade is arranged closer to the first side than the channel entrance. According to a further preferred embodiment of the tool an axis of the guiding element encloses an angle between 45 and 90° with the first direction.

The axis is defined to comprise both the attachment point and the tip of the guiding element.

In this configuration a user who grips the grip between the channel and the second side can move the tool second side first, which is particularly efficient for cutting the longitudinal object.

According to a further preferred embodiment of the tool, in the first direction, a distance between the attachment point of the guiding element and the first side of the grip is between 0.5 and 3 cm.

The distance is preferably between 1 and 2 cm. Surprisingly, using such a distance can be advantageous even compared to using the smallest distance achievable. This is due to the fact that with such a distance the part of the grip surface between the attachment point and the first side can be used to abut a surface the longitudinal object may be in contact with. This way, the surface part in question may provide a lever effect, by means of which the longitudinal object can be separated from the surface.

According to a further preferred embodiment of the tool the blade is oriented along the first direction.

It was found that this way the longitudinal object can be moved toward the blade at an angle that is particularly efficient for cutting the longitudinal object.

According to a further preferred embodiment the tool further comprises at least one foldable tool element.

The tool element can be considered as an additional tool element. The tool element is provided in addition to the guiding element. The at least one tool element can be a knife, a screwdriver, a cork-screw and/or a can opener. Preferably, the tool is configured in a pocketknife manner such that the one or more tool element(s) and the guiding element are elements that can be folded in and out.

By providing the at least one tool element the described tool can be used for a plurality of purposes beside cutting longitudinal objects with the blade in the channel.

According to a further preferred embodiment of the tool an extension of the guiding element from the attachment point to the tip is 30 to 65% of an extension of the grip in the first direction from the first side to the second side.

The extension of the guiding element from the attachment point to the tip can be considered to be the length of the guiding element. Using an extension in the stated range was found to be a reasonable compromise between the possibility to store the guiding element in the folded-in position within the grip and providing a sufficiently large lever arm for separating the longitudinal object from a surface it might be in close contact to.

According to a further aspect of the invention a use of a described tool for cutting single-use handcuffs as the longitudinal object is provided.

The details and advantages disclosed for the tool can be applied to the described use, and vice versa.

According to a preferred embodiment of the use the single-use handcuffs are configured in a cable tie manner.

It should be noted that the individual features specified in the claims may be combined with one another in any desired technologically reasonable manner and form further embodiments of the invention. The specification, in particular taken together with the figures, explains the invention further and specifies particularly preferred embodiments of the invention. Particularly preferred variants of the invention and the technical field will now be explained in more detail with reference to the enclosed figures. It should be noted that the exemplary embodiment shown in the figures is not intended to restrict the invention. The figures are schematic and may not be to scale. The figures display:

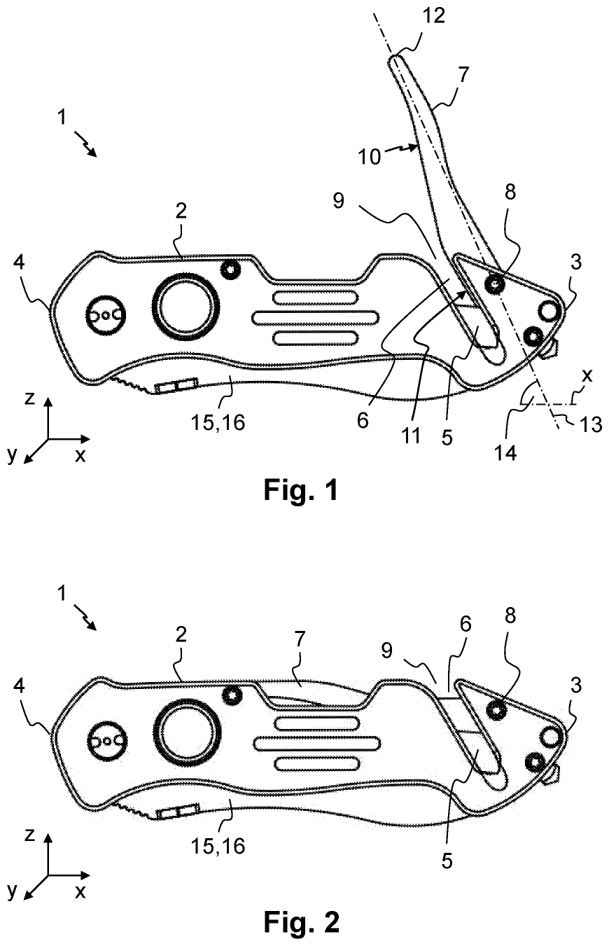

FIG. 1: a side view of a tool according to the invention, wherein the guiding element is folded out,

FIG. 2: the tool of FIG. 1, wherein the guiding element is folded in.

FIG. 1 shows a tool 1 for cutting a longitudinal object (not shown). The longitudinal object can be a single-use handcuff, in particular configured in a cable tie manner.

In order to describe the tool 1, a coordinate system is used having a first direction x, a second direction y and a third direction z (which is perpendicular to the drawing plane), each of which being orthogonal to both respective other directions. The tool 1 comprises a grip 2. Along the first direction x the grip 2 extends between a first side 3 and a second side 4.

Further, the tool 1 comprises a blade 5 arranged in a channel 6 within the grip 2. The channel 6 and the blade 5 are arranged such that the longitudinal object is receivable and guidable toward the blade 5 by the channel 6. The channel 6 is open on two opposite sides in the second direction y such that the longitudinal object can be moved through the channel 6 if the longitudinal object is oriented along the second direction y, that is perpendicular to the drawing plane.

In the first direction x the channel 6 is arranged closer to the first side 3 than to the second side 4 of the grip 2. That is, in FIG. 1 the channel 6 is located closer to the right edge of the grip than to the left edge. This defines what is the first side 3 and the second side 4.

Further, the tool 1 comprises a guiding element 7, which is configured in a foldable manner such that if folded out the guiding element 7 extends from the grip 2 such that the longitudinal object is guidable toward a channel entrance 9 by the guiding element 7. In FIG. 1 the guiding element 7 is shown in the folded-out position.

The guiding element 7 is attached to the grip 2 at an attachment point 8, which is, in the first direction x, located between the channel entrance 9 and the first side 3.

The guiding element 7 has a guiding surface 10 that is in line with a channel surface 11 of the channel 6 if the guiding element 7 is folded out as shown in FIG. 1. The guiding element 7 is tapered toward a tip 12 of the guiding element 7. The tip 12 is rounded. The guiding element 7, the channel 6 and the blade 5 are arranged such that the longitudinal object, once received in the channel 6, can be forced onto the blade 5 by the guiding element 7 by folding in the guiding element 7. In FIG. 1 folding in the guiding element 7 means to rotate the guiding element 7 counter-clockwise about an axis through the attachment point 8 that is perpendicular to the drawing plane. The guiding element 7 is lockable if folded out as shown in FIG. 1. The channel 6 is tilted in such a way that, in the first direction x, the blade 5 is arranged closer to the first side 3 than the channel entrance 9. That is, the channel 6 runs between top left and bottom right in FIG. 1. An axis 13 of the guiding element 7, which is defined by comprising the attachment point 8 and the tip 12, encloses an angle 14 between 45 and 90° with the first direction x. In the first direction x, a distance between the attachment point 8 of the guiding element 7 and the first side 3 of the grip 2 is between 0.5 and 3 cm. The blade 5 is oriented along the first direction x. Besides the guiding element 7, the tool 1 further comprises a knife 16 as a foldable tool element 15. An extension of the guiding element 7 from the attachment point 8 to the tip 12 is 30 to 65% of an extension of the grip 2 in the first direction x from the first side 3 to the second side 4.

In FIG. 2 the tool 1 of FIG. 1 is shown with the guiding element 7 being folded in. In that case the guiding element 7 is contained in a recess (not shown) within the grip 2. The guiding element 7 is lockable if folded in.

With the tool 1 a longitudinal object such as a single-use handcuff can be cut in a particularly safe way because the blade 5 cannot be touched within the channel 6. With the foldable guiding element 7 the longitudinal object can be separated from a surface it might be in close contact with such as an arm of a cuffed person.

### LIST OF REFERENCE NUMERALS

1 tool
2 grip
3 first side
4 second side
5 blade
6 channel
7 guiding element
8 attachment point
9 channel entrance
10 guiding surface
11 channel surface
12 tip
13 axis
14 angle
15 foldable tool element
16 knife
x first direction
y second direction
z third direction

1. Tool for cutting a longitudinal object, comprising:
a grip extending between a first side and a second side in a first direction,
a blade arranged in a channel within the grip, wherein the channel and the blade are arranged such that the longitudinal object is receivable and guidable toward the blade by the channel, wherein, in the first direction, the channel is arranged closer to the first side than to the second side of the grip,
a guiding element, which is attached to the grip at an attachment point, wherein the attachment point is, in the first direction, located between a channel entrance and the first side, wherein the guiding element is attached to the grip in a foldable manner such that if folded out the guiding element extends from the grip to guide the longitudinal object toward the channel entrance.

2. Tool according to claim 1, wherein the guiding element has a guiding surface that is in line with a channel surface of the channel if the guiding element is folded out.

3. Tool according to claim 1, wherein the guiding element is tapered toward a tip of the guiding element.

4. Tool according to claim 1, wherein the guiding element has a rounded tip.

5. Tool according to claim 1, wherein the guiding element, the channel and the blade are arranged such that the longitudinal object, once received in the channel, can be forced onto the blade by the guiding element by folding in the guiding element.

6. Tool according to claim 1, wherein the guiding element is contained in a recess within the grip if the guiding element is folded in.

7. Tool according to claim 1, wherein the guiding element is lockable if folded out and/or if folded in.

8. Tool according to claim 1, wherein the channel is tilted in such a way that, in the first direction, the blade is arranged closer to the first side than the channel entrance.

9. Tool according to claim 1, wherein an axis of the guiding element encloses an angle between 45 and 90° with the first direction.

10. Tool according to claim 1, wherein, in the first direction, a distance between the attachment point of the guiding element and the first side of the grip is between 0.5 and 3 cm.

11. Tool according to claim 1, wherein the blade is oriented along the first direction.

12. Tool according to claim 1, further comprising at least one foldable tool element.

13. Tool according to claim 1, wherein an extension of the guiding element from the attachment point to the tip is 30 to 65% of an extension of the grip in the first direction from the first side to the second side.

14. Use of a tool according to claim 1 for cutting single-use handcuffs as the longitudinal object.

15. Use according to claim 14, wherein the single-use handcuffs are configured in a cable tie manner.
